(19) United States
(12) Patent Application Publication
(10) Pub. No.: US 2025/0174626 A1
(43) Pub. Date: May 29, 2025

(54) METHOD FOR IMPROVED PRELOADING OF BATTERY ELECTRODES WITH METAL IONS, AND PRELOADED BATTERY ELECTRODES WITH IMPROVED ELECTRICAL PROPERTIES

(71) Applicant: FORSCHUNGSZENTRUM JÜLICH GMBH, Jülich (DE)

(72) Inventors: Egbert FIGGEMEIER, Leichlingen (DE); Hyunsang JOO, Aachen (DE)

(73) Assignee: FORSCHUNGSZENTRUM JÜLICH GMBH, Jülich (DE)

(21) Appl. No.: 18/841,108

(22) PCT Filed: Feb. 24, 2023
(86) PCT No.: PCT/EP2023/054695

§ 371 Date: Aug. 23, 2024

(30) Foreign Application Priority Data
Feb. 25, 2022 (DE) 10 2022 104 630.3

(51) Int. Cl. H01M 4/04; H01M 4/02; H01M 4/1393; H01M 4/1395; H01M 4/26; H01M 10/0525; H01M 10/054; H01M 10/0567; H01M 10/0569; H01M 10/28

(52) U.S. Cl. CPC H01M 4/0447; H01M 4/1393; H01M 4/1395; H01M 4/26; H01M 10/0525; H01M 10/054; H01M 10/0567; H01M 10/0569; H01M 10/288; H01M 2004/021

(57) ABSTRACT

The present invention relates to a process for producing an electrode for an alkaline ion ac-cumulator, wherein the process comprises at least the process steps:
a) Providing an electrode layer pre-loaded with alkali ions and
b) currentless contacting of the pre-loaded electrode layer provided in process step a) with a solution comprising an organic solvent and at least one additive dissolved therein, the addi-tive being selected from the group consisting of carbon dioxide, organic carbonates, organic silanes, derivatives thereof or mixtures of at least two additives from this group, and cur-rentless deposition of at least part of the additive onto the pre-loaded electrode layer in the absence of an electrolyte salt. Furthermore, the present invention relates to pre-loaded elec-trodes produced by the process according to the invention and to the use of the process for producing electrodes for alkaline ion accumulators.

The present invention relates to a process for producing an electrode for an alkaline ion accumulator, wherein the process comprises at least the process steps:
a) Providing an electrode layer pre-loaded with alkali ions and
b) currentless contacting of the pre-loaded electrode layer provided in process step a) with a solution comprising an organic solvent and at least one additive dissolved therein, the additive being selected from the group consisting of carbon dioxide, organic carbonates, organic silanes, derivatives thereof or mixtures of at least two additives from this group, and currentless deposition of at least part of the additive onto the pre-loaded electrode layer in the absence of an electrolyte salt. Furthermore, the present invention relates to specially preloaded electrodes produced by the process according to the invention and to the use of the process for producing electrodes for alkaline ion accumulators.

In many cases, the success of innovative electrical and electronic consumer goods is closely linked to their application properties, with users focusing in particular on reliable and long-lasting autonomous use for smartphones, laptops or electrically powered vehicles, for example. For this reason, great efforts are being made by industry and research in the field of rechargeable batteries to increase their electrical performance, longevity and cost efficiency. Alkaline and lithium-ion-based cells are the most promising energy sources, as they can currently provide the highest energy densities with practical lifetimes. The physical/chemical basis of the current output of Li-ion batteries is linked to the reversible storage and retrieval of Li-ions in the electrodes of the battery structure, whereby the charge status and the cell voltage are also a function of the total amount of Li stored.

In conventional lithium-ion battery production processes, the electrochemically active lithium is supplied to the cell exclusively via the positive electrode using lithiated metal oxides such as lithium cobalt oxide. However, in order to further increase the service life and energy density, the various negative electrodes are now also lithiated before the cell is assembled or consist entirely of a lithium foil. This process is known as “pre-lithiation” and can provide a predetermined proportion of the maximum storable energy even before the battery is charged for the first time by the end user. Due to the fact that the pre-lithiation of electrodes is decoupled from the actual chemical environment of the battery, the choice of chemical and physical environmental conditions during pre-lithiation can also result in other electrode structures that do not occur within the chemical environment of the actual battery. This decoupling during pre-lithiation can be used to produce more advantageous electrode structures with improved electrical properties.

The patent literature also provides a wide variety of approaches for pre-loading electrodes with metal ions.

For example, EP 0 498 049 A1 describes an electrochemical secondary element with a positive electrode whose active material comprises a lithium-intercalating chalcogen compound of a transition metal, a negative electrode whose active material comprises a lithium-intercalating carbon product with a disordered lattice structure formed from organic substances by a sustained coking process, and a non-aqueous electrolyte, characterized in that, in the installed state of the cell, the transition metal chalcogenide is charged with lithium and in that the carbon material is charged by pre-lithiation only with such an amount of lithium as is irreversibly bound in the carbon skeleton by chemical reaction.

Furthermore, DE 11 2017 006 921 T5 discloses a lithium-ion cell comprising a positive electrode, a negative electrode and an electrolyte, wherein the positive electrode contains an active material for the positive electrode and a pre-lithiation source from a group of LiVO₃, LiV₃O₈, Li₃VO₄, Li₂C₂ and any combinations thereof, preferably Li₂C₂.

Furthermore, DE 10 2021 105 975 A1 describes a method for producing a pre-lithiated electrode for a lithium-ion battery cell, the method comprising: electrochemically bonding a magnesium-lithium alloy to an electrode; pre-lithiating the electrode by transferring lithium ions from the magnesium-lithium alloy to the electrode; and electrochemically separating the magnesium-lithium alloy from the electrode.

Such solutions known from the state of the art can offer further potential for improvement. This relates to the overall electrical properties and in particular to the cycle stability and the specific capacity of pre-loaded electrode layers in alkaline-ion cells.

It is therefore the task of the present invention to at least partially overcome the disadvantages known from the prior art and to provide a process for producing and improving pre-loaded electrode layers and electrodes for alkaline-ion batteries. In particular, it is the task of the present invention to provide a process for treating pre-loaded electrode layers which can be carried out in a highly reproducible and cost-effective manner, functions independently of the actual pre-loading process and provides modified pre-loaded electrodes which are characterized by improved electrical properties.

The problem is solved by the features of the independent claims, directed to the process according to the invention, electrodes produced by the process according to the invention and the use of the process according to the invention for producing pre-loaded electrodes. Preferred embodiments of the invention are defined in the dependent claims, in the description or in the figures, whereby further features described or shown in the dependent claims, in the description or in the figures may constitute an object of the invention individually or in any combination, as long as the context does not clearly indicate the contrary.

Accordingly, according to the invention, an electrode for an alkaline-ion accumulator is produced, characterized in that the process comprises at least the following process steps:
a) Providing an electrode layer pre-loaded with alkali ions and
b) currentless contacting of the pre-loaded electrode layer provided in process step a) with a solution comprising an organic solvent and at least one additive dissolved therein, the additive being selected from the group consisting of carbon dioxide, organic carbonates, organic silanes, derivatives thereof or mixtures of at least two additives from this group, and currentless deposition of at least part of the additive onto the pre-loaded electrode layer in the absence of an electrolyte salt.

Surprisingly, it was found that the treatment of a pre-loaded electrode in a currentless state, and in particular in a chemical environment outside of conventional battery cell arrangements without electrolyte, with the above-mentioned specific additives leads to improved electrical behavior of the electrodes in battery or accumulator operation. The electrode layers and electrodes preconditioned by additional deposition of the specified additives can in particular exhibit improved electrical properties, for example in the form of improved cycle stability in battery operation. Without being bound by theory, this effect can probably be attributed to the fact that by depositing or depositing the additives on an already at least partially pre-loaded electrode, without the influence of electrical voltages or electrical currents and in particular in the absence of an electrolyte, a particularly efficient deposition structure of the additive is obtained on the electrode material and on the already partially embedded alkali ions, which leads to particularly cycle-stable electrode layers in actual battery operation. The latter can in particular probably also result from the fact that the deposition of the additives is carried out without simultaneous further or additional deposition of alkali ions on the electrode, so that a particularly delimited additive layer can be obtained on the electrode material itself or on the alkali ions already stored.

The process according to the invention is a process for producing an electrode for an alkaline-ion accumulator. The electrical properties of alkaline ion accumulators are based on the transfer of alkaline ions, such as lithium, sodium or potassium, between two battery electrodes. Typical lithium-ion batteries or accumulators consist of a first and a second electrode with an electrolyte material and a separator between them. Several lithium-ion battery cells are often electrically connected together in stacks to increase the overall performance. Conventional lithium-ion batteries function by reversibly transferring lithium ions between the negative and positive electrodes and storing or removing them. The electrolyte present in the batteries as such is suitable for conducting lithium ions and can be in solid or liquid form. The electrodes for these accumulators usually comprise a metallic arrester and an active material arranged on it, which is suitable for the reversible absorption and release of lithium. The process presented here deals with the further conditioning of electrode materials already pre-loaded with alkali ions.

In process step a), an electrode layer pre-loaded with alkali ions is provided. The process according to the invention is carried out on electrodes which are located outside the chemical environment of a battery or an accumulator. The electrode layer can comprise either only the electrode active material or, for example, an electrical arrester in the form of a metal foil and the actual electrode material. The electrode layer is suitable for the reversible incorporation and removal of alkaline and, in particular, lithium ions. As a function of the electrical potential, alkali ions can be stored in and removed from the active material of the electrode. The electrode material of the electrode layer is already pre-loaded, i.e. the electrode material of the electrode layer has at least a partial charge of alkali ions, which are stored in the electrode structure. The proportion of pre-loading can, for example, be between 5% and 100% of the theoretically possible load. The actual pre-loading of the electrode with alkali ions can take place, for example, in a suitable electrolyte solution via a current flow.

In process step b), the pre-loaded electrode layer prepared in process step a) is contacted with a solution in an electroless process. The pre-loaded electrode is further processed outside the chemical environment of the pre- loading bath. For this purpose, the pre-loaded electrode layer or electrode is transferred to another liquid process solution. In this process solution, the electrode layer is treated without the application of a voltage or the flow of an electric current. This can be achieved, for example, by immersing the electrode layer in a bath containing the process solution for a certain period of time. Immersion in the solution can take place over a period of 30 minutes to several hours, for example. The solution can have a temperature of 0° C. to 60° C., for example. The electrode can also be immersed or rinsed at room temperature, for example. The amount of solution is not critical as long as the entire electrode surface is wetted by the solution. Conveniently, the weight ratio of electrode to solution can be more than 1:100, further preferably more than 1:500 and further preferably more than 1:1000.

The solution comprises an organic solvent and at least one additive dissolved therein. The organic solvent can, for example, be a solvent that is used in the field of alkaline ion batteries and, in particular, lithium ion batteries. Common solvents from this field can be, for example, cyclic organic carbonates such as ethylene carbonate or propylene carbonate, acyclic carbonates such as dimethyl carbonate, diethyl carbonate or ethyl methyl carbonate, aliphatic carboxylic acid esters such as methyl formate, methyl acetate or methyl propionate, gamma-lactones such as gamma-butyrolactone or gamma-valerolactone, acyclic esters such as 1,2-dimethoxyethane, 1,2-diethoxyethane or ethoxymethoxyethane, or cyclic esters such as tetrahydrofuran or 2-methyltetrahydrofuran can be used. However, solvents such as tetrahydrofuran (THF), alcohols, organic esters and ethers can also be used. The concentration of the solvents is not critical, but can preferably be greater than 70 wt. %, further preferably greater than 80 wt. % and further preferably greater than 90 wt. %.

The additive is selected from the group consisting of carbon dioxide, organic carbonates, organic silanes, their derivatives or mixtures of at least two additives from this group. In addition to the actual solvent, the solution contains at least one other substance, which is at least partially deposited on the electrode surface during the treatment or immersion of the preloaded electrode. Without being bound by the theory, the additive interacts with the electrode surface or the preloaded electrode surface and thus contributes to stabilizing the electrical performance of the electrode structure. The additives can be used, for example, in a concentration of greater than or equal to 0.5% by weight and less than or equal to 30%, further preferably greater than or equal to 1.0% by weight and less than or equal to 25% and further preferably greater than or equal to 2.5% by weight and less than or equal to 20%.

Possible organic carbonates have more than two C-atoms and therefore differ from inorganic carbonates. Possible representatives of this group are, for example, substituted or unsubstituted cyclic or acyclic C2-C8 carbonates.

The organic silanes can, for example, be selected from the group consisting of unsubstituted or substituted silanes or mixtures of at least two members thereof. Possible substituted silanes are, for example, the cyano-silanes. For example, the silanes can be of the formula (RO)_{X}—Si—[(CH₂)_{y}—Z]₍₄₋ₓ₎, where Z can be a hydrogen or a monovalent substituent, for example—CN. The R in the formula can stand for a linear, branched or cyclic C1-C7 alkyl group. The alkyl group can also have one or two further substituents. The index x can be 1-3 and the index y can be 1-5. Possible representatives of this group are, for example, (CH₃CH₂O)₃Si(CH₂)₂CN or (CH₃CH₂O)₃Si(CH₂)₃CN.

In process step b), at least part of the additive is deposited on the pre-loaded electrode layer in the absence of an electrolyte salt. During the immersion treatment of the electrode in the solvent bath, some of the additives are deposited on the pre-loaded electrode layer by pure diffusion. There, the additives can react with the electrode material or the pre-loaded electrode material. Preferably more than 0.01% by weight, more preferably more than 0.05% by weight and more preferably more than 0.1% by weight of additive relative to the weight of the pre-loaded electrode are deposited by pure diffusion processes in the solution without further electrical driving forces.

In a preferred embodiment of the process, the solvent may be selected from the group consisting of substituted or unsubstituted C3-C8 carbonates, gamma-butyrolactone, acetonitrile or mixtures of at least two solvents from this group. This group of solvents appears to be particularly suitable for obtaining particularly stable pre-loaded electrodes during the electroless deposition of the additives, which can exhibit an improved number of cycles in charge/discharge processes. Without being bound by theory, this may be due to the fact that the solvent itself is partially incorporated into the pre-loaded electrode structure and causes a change in the electrical properties of the pre-charged electrode layer. Another effect may be that these solvents provide a favorable solubility for the additives and contribute to a very efficient deposition of the additives on the preloaded electrode layer.

In a further preferred embodiment of the process, the solvent can be selected from the group consisting of ethylene carbonate, dimethyl carbonate, ethyl methyl carbonate, diethyl carbonate, propylene carbonate, gamma-butyrolactone or mixtures of at least two solvents from this group. This group of solvents appears to be particularly suitable for obtaining particularly stable pre-loaded electrodes during the electroless deposition of the additives, which can exhibit an improved number of cycles in charge/discharge processes. In addition, the pre-loaded electrode layers treated in this way can have an improved initial capacitance. Without being bound by theory, this may be due to the fact that the solvent itself is partially incorporated into the preloaded electrode structure and causes a change in the electrical properties of the pre- loaded electrode.

Within a further preferred aspect of the process, the additive may be selected from the group of fluorinated organic C2-C5 carbonates. This group of additives can be cyclic or non-cyclic compounds, whereby the term organic carbonates indicates that they are not inorganic, salt-like carbonates. This group of organic carbonates in particular can lead to a particularly efficient stabilization of the electrode layer, resulting in improved cycle stability as a function of the number of charge/discharge cycles. In addition, the pre- loaded electrodes treated in this way can have an improved initial capacity. Possible compounds from this group are, for example, mono- or di-fluorinated vinyl carbonate or, for example, mono-, di- or trifluoropropylene carbonate.

In a further preferred embodiment of the process, the additive can be carbon dioxide. In particular, the use of carbon dioxide as an additive can surprisingly result in particularly long-term stable batteries whose specific discharge capacity decreases to a significantly lesser extent compared to untreated pre-loaded, for example pre-lithiated electrodes or samples pre-loaded with other additives. It can be seen from the examples that the pre-loaded electrode layers treated with carbon dioxide in this way have a particularly stable specific discharge capacity over the number of cycles.

According to a preferred characteristic of the process, in process step a) the electrode can be pre-loaded to a pre-load level of greater than or equal to 5% and less than or equal to 70%. Surprisingly, it was found that the degree of pre-loading before the additional treatment according to the invention also has an influence on the electrical performance parameters of accumulators or batteries produced with these electrodes. Within these ranges of pre-loading, further treatment can result in particularly long-term stable electrode layers, electrodes and battery arrangements. Further preferably, the degree of pre-loading can be greater than or equal to 10% and less than or equal to 50%, further preferably greater than or equal to 12.5% and less than or equal to 35%. The pre-loading of the active material is given in relation to the maximum charge capacity of the electrode layer. The maximum loading can be calculated from the maximum loadings of the pure active materials and the percentage composition in the electrode layer. The maximum loading of the active materials with alkali ions can also be taken from the literature or the manufacturer's specifications. A possible direct experimental determination method involves the use of battery cell arrangements with, for example, a lithium metal electrode and the corresponding electrode via the integration of the current over time. The electrode is discharged with lithium from the initial voltage after installation up to a final voltage of 0.02 V and the charge is determined accordingly via the time integral of the current.

Within a preferred aspect of the process, the concentration of the additives in process step b) may be greater than or equal to 2% by weight and less than or equal to 20% by weight. These concentration ranges of additives have proven to be particularly suitable for obtaining a preloaded electrode surface that is treated as uniformly as possible. Uniform loading can be achieved within very short process times, which has a positive effect on the electrical properties of the electrode layer and thus the entire electrode.

In a further preferred embodiment of the process, the electrode can be a graphite/silicon composite electrode. It has been shown that the process according to the invention can be used in particular to improve the electrical properties of electrode layers which comprise two different active materials and, in particular, silicon and carbon in significant proportions by weight. In particular, the carbon weight fraction of the electrode layer can be greater than or equal to 30% by weight and less than or equal to 60% by weight and the silicon weight fraction of the electrode layer can be greater than or equal to 10% by weight and less than or equal to 60% by weight relative to the total weight of the electrode layer. This configuration may be particularly suitable for Li-ion batteries.

In a further embodiment of the process, the electrode layer can have a porosity determined by mercury porometry of greater than or equal to 10% and less than or equal to 55%. The use of porous electrode active materials with the above-mentioned degree of porosity has proved to be particularly suitable for the treatment of the pre-lithiated electrodes according to the invention. Within this porosity range, particularly improved and particularly long-term stable electrodes can be obtained, which also have a particularly high specific discharge capacity. Further preferably, the porosity can be greater than or equal to 15% and less than or equal to 45% and further preferably greater than or equal to 20% and less than or equal to 40%.

Pre-loaded electrodes obtained by the process according to the invention are also in accordance with the invention. The additionally modified electrode layers obtained by the process according to the invention can have a particularly stable surface whose electrochemical properties remain very stable even after many charge/discharge cycles. In addition to the increased longterm stability, the electrodes produced in this way can have an improved electrical storage capacity for alkali ions. Without being bound by theory, the additional treatment by the additives present in the solvent seems to result in special complexes with the materials of the pre-loaded electrode, which improve the electrical properties. Surprisingly, the advantages result from a purely diffusion-driven deposition without further electrochemical forces, which can also change the charge status of the pre-loaded electrode surface or possibly the additives.

Further according to the invention is the use of the process according to the invention for the production of a pre-loaded electrode for use in an alkaline-ion accumulator. The treated, preloaded electrodes according to the invention can be used in particular in a battery structure of an alkaline-ion cell. In the latter, the electrodes produced according to the process of the invention improve the long-term electrical stability of the structure and, in particular, also increase the specific discharge capacity. Overall, a higher electrical output can therefore be provided over a longer period of time.

### EXAMPLES

### 1. Production of a Graphite/Silicon Electrode

A homogeneous powder mixture of graphite, silicon, carbon black and the binders is produced using a mixer. The mixture is dispersed in deionized water and neutralized with LiOH if necessary. The dispersion is applied to a Cu-substrate (0.01 mm thick) via a coating device and dried. The electrode layer coated onto the metallic conductor and dried is then calendered to a target porosity of approx. 30%. The electrode layer used in the following measurements has the following composition: Graphite 70 wt %, silicon in the form of SiOₓ 20 wt %, binder (polyacrylic acid, carboxymethyl cellulose, styrene-butadiene rubber) approx. 8 wt %, and 2 wt % conductivity additive.

The physical properties of the anode produced in this way are as follows: Thickness of the electrode layer 0.044 mm, weight of the electrode layer 0.03 g, weight of the active material 0.012 g, application quantity 6.051 mg/cm²; density of the electrode layer 1.375 g/cm³, capacity 7.568 mAh, surface capacity 3.764 mAh/cm², specific capacity 622.018 mAh/g.

### 2. Pre-Lithiation of the Anode

For controlled pre-lithiation of the electrodes, 0.8 M LiCl in gamma butyrolactone (GBL) is used as the electrolyte solution. The lithiated anodes are produced using a button cell assembly with a lithium metal counter electrode. The anodes are lithiated at a constant rate of 0.2 C in this setup. The lithiation rate is set as a function of the electrical capacity reached, with the maximum anode capacity being 7.6 mAh. After reaching the specified electrical target capacity of 18%, the anodes were removed from the button cells.

### 3. Electroless Pretreatment of the Pre-Lithiated Electrodes According to the Invention

The anodes pre-lithiated under 2. are immersed for 10 minutes at room temperature in the gamma-butyrolactone solutions specified in the following table with the specified quantities of the corresponding additives. The solutions did not contain any other substances.

| Sample Designation | Additive |
|---|---|
| P0R0 | — |
| P0Rc | 5% by weight CO₂ |
| P0Rv | 5% by weight vinylene carbonate |
| P0Rf | 5% by weight fluoroethylene carbonate |
| P0Rt | 5% by weight (2-cyanoethyl)triethoxysilane |

The immersed and removed electrodes were combined with a positive counter electrode (cathode), a separator to prevent an electrical short circuit and an electrolyte solution using a button cell assembly. The cathode consists of 95.5% by weight of a mixed oxide (nickel (60 mol %), manganese (20 mol %), cobalt (20 mol %)), 2% by weight of SuperP and 2.5% by weight of PVDF. The electrolyte of the cell assembly consists of 1M LiPF₆ in ethylene carbonate/ethylene methylene carbonate (ratio 3:7 (LP57)) with 10% fluoroethylene carbonate. A glass fiber membrane was used as a separator. The ratio of the capacities of the negative and positive electrodes is 1.07 in all experiments and refers to the capacity of the negative electrode after pre-lithiation in GBL as described above. The electrical parameters of the charge-discharge cycles to determine the battery properties of the electrodes produced are listed in the table below;

| | | Cut-off volt- | | | Cut-off |
|---|---|---|---|---|---|
| | | age | C-rate | Mode | current |
| Formation | Loading/ | 2.9-4.2 V | 0.05Cx1 + | CC | — |
| | unloading | | 0.1Cx2 | | |
| Cycling | Loading | 4.2 V | 0.5 C | CCCV | 0.05 C |
| | Unloading | 2.9 V | 0.5 C | CC | — |

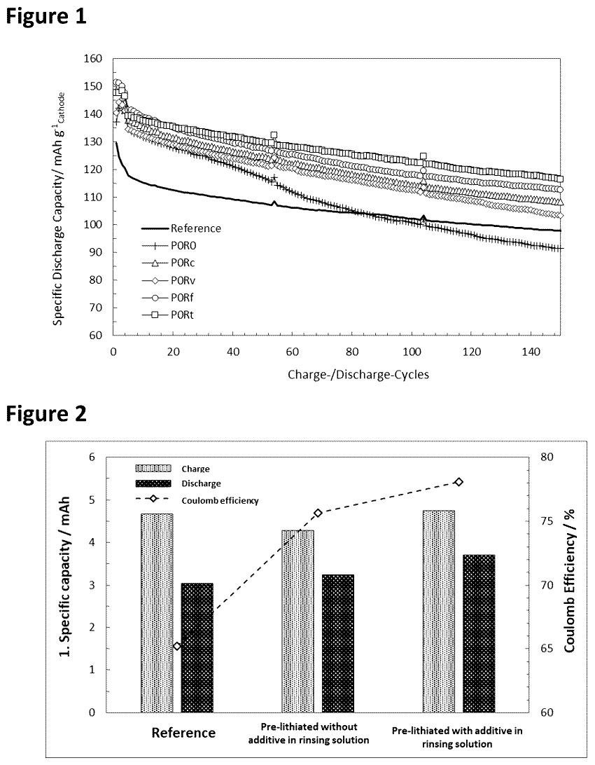

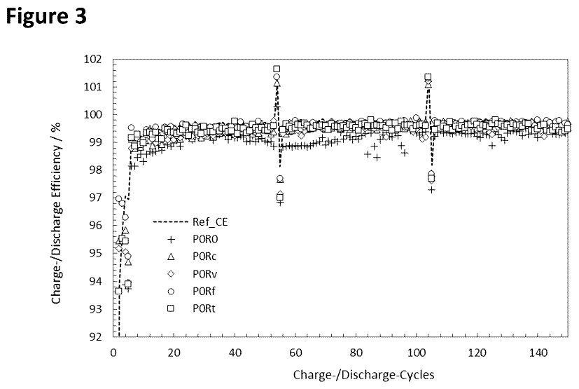

The course of the capacity as a function of the number of charge-discharge cycles is shown for the differently treated electrodes in FIG. 1. FIG. 3 shows the ratio of the amount of charge between a charging and discharging process as a function of the number of charge-discharge cycles. In contrast to the untreated reference electrode (PORO), a significant improvement in the long-term stability of the specific discharge capacity can be observed for the electrodes according to the invention, which were immersed in a solvent with the above-mentioned additives after pre-lithiation. Furthermore, it can be clearly seen that the initial capacity for the treated electrodes is significantly increased by the incorporation of the additives. Overall, the pre-treatment of the anodes in a de-energized state in the absence of an electrolyte results in anodes with improved electrical properties.

FIG. 2 shows once again the results for the discharge capacity and Coulombic efficiency for non-pre-lithiated electrodes, pre-lithiated electrodes without pre-charging with additives according to the invention and a pre-lithiated and charged electrode according to the invention. It is clear from these results that the Coulombic efficiency can be increased by a further approx. 2% compared to conventionally pre-lithiated electrodes.

1. Process for producing an electrode for an alkaline-ion accumulator, characterized in that the process comprises at least the following process steps:
a) Providing an electrode layer pre-loaded with alkali ions and
b) currentless contacting of the pre-loaded electrode layer provided in process step a) with a solution comprising an organic solvent and at least one additive dissolved therein, the addi-tive being selected from the group consisting of carbon dioxide, organic carbonates, organic silanes, derivatives thereof or mixtures of at least two additives from this group, and cur-rentless deposition of at least part of the additive onto the pre-loaded electrode layer in the absence of an electrolyte salt.

2. The process according to claim 1, wherein the solvent is selected from the group con-sisting of substituted or unsubstituted C3-C8 carbonates, gammabutyrolactone, acetonitrile or mixtures of at least two solvents from this group.

3. The process according to claim 1, wherein the solvent is se-lected from the group consisting of ethylene carbonate, dimethyl carbonate, ethyl methyl carbonate, diethyl carbonate, propylene carbonate, gamma-butyrolactone or mixtures of at least two solvents from this group.

4. The process according to claim 1, wherein the additive is selected from the group consisting of fluorinated organic C2-C5 carbonates.

5. The process according to claim 1, wherein the additive is carbon dioxide.

6. The process according to claim 1, wherein in process step a) the electrode is pre-loaded to a pre-loaded level of greater than or equal to 5% and less than or equal to 70%.

7. The process according to claim 1, wherein the concentration of the additives in process step b) is greater than or equal to 2% by weight and less than or equal to 20% by weight.

8. The process according to claim 1, wherein the electrode is a graphite/silicon composite electrode and the alkali metal ion is lithium.

9. The process according to claim 8, wherein the electrode layer has a porosity deter-mined by mercury porometry of greater than or equal to 10% and less than or equal to 55%.

10. Electrode pre-loaded with alkali metal ions obtained by a process according to claim 1.

11. Use of a process according to claim 1 for producing a pre-loaded electrode for use in an alkaline ion accumulator.
